(19) United States
(12) Patent Application Publication
(10) Pub. No.: US 2017/0154264 A1
(43) Pub. Date: Jun. 1, 2017

(54) AUTONOMOUS COLLABORATION AGENT FOR MEETINGS

(71) Applicant: International Business Machines Corporation, Armonk, NY (US)

(72) Inventors: Stanley Chen, New York, NY (US); Kenneth W. Church, Dobbs Ferry, NY (US); Robert G. Farrell, Cornwall, NY (US); Vaibhava Goel, Chappaqua, NY (US); Lidia L. Mangu, New York, NY (US); Etienne Marcheret, White Plains, NY (US); Michael A. Picheny, White Plains, NY (US); Bhuvana Ramabhadran, Mount Kisco, NY (US); Laurence P. Sansone, Beacon, NY (US); Abhinav Sethy, Chappaqua, NY (US); Samuel Thomas, Elmsford, NY (US)

(21) Appl. No.: 14/953,727

(22) Filed: Nov. 30, 2015

(51) Int. Cl. G06N 5/02; G10L 15/02

(52) U.S. Cl. CPC G06N 5/02; G10L 15/02

(57) ABSTRACT

A method, executed by a computer, includes monitoring a conversation between a plurality of meeting participants, identifying a conversational focus within the conversation, generating at least one question corresponding to the conversational focus, and retrieving at least one answer corresponding to the at least one question. A computer system and computer program product corresponding to the method are also disclosed herein.

### BACKGROUND OF THE INVENTION

The present invention relates generally to the field of communication, and more particularly to computer augmented communications.

Meetings often include a diverse set of participants whose background, expertise, functional roles, and knowledge vary considerably. Some meeting participants may find it difficult to understand all of the information presented in the meeting. In some cases, multiple meetings are held and the attendees vary with each meeting. Consequently, many meetings are ineffective and often filled with redundant information.

### SUMMARY

As disclosed herein, a method, executed by a computer, includes monitoring a conversation between a plurality of meeting participants, identifying a conversational focus within the conversation, generating at least one question corresponding to the conversational focus, and retrieving at least one answer corresponding to the at least one question. A computer system and computer program product corresponding to the method are also disclosed herein.

### BRIEF DESCRIPTION OF THE DRAWINGS

FIG. 1 is a functional block diagram depicting one example of a conversation enhancement system accordance with at least one embodiment of the present invention;

FIG. 2 is a flowchart depicting one example of a conversation enhancement method in accordance with at least one embodiment of the present invention;

FIGS. 3A, 3B, and 4 are illustrations depicting several examples of an annotated conversation in accordance with at least one embodiment of the present invention; and

FIG. 5 is a block diagram depicting one example of a computing apparatus (i.e., computer) suitable for executing the methods disclosed herein.

### DETAILED DESCRIPTION

The embodiments disclosed herein recognize a need for annotating conversations that occur between meeting participants so that each participant can understand and effectively participate in the conversation. The annotations may be unobtrusive and personalized so that effective communication and coordination may occur.

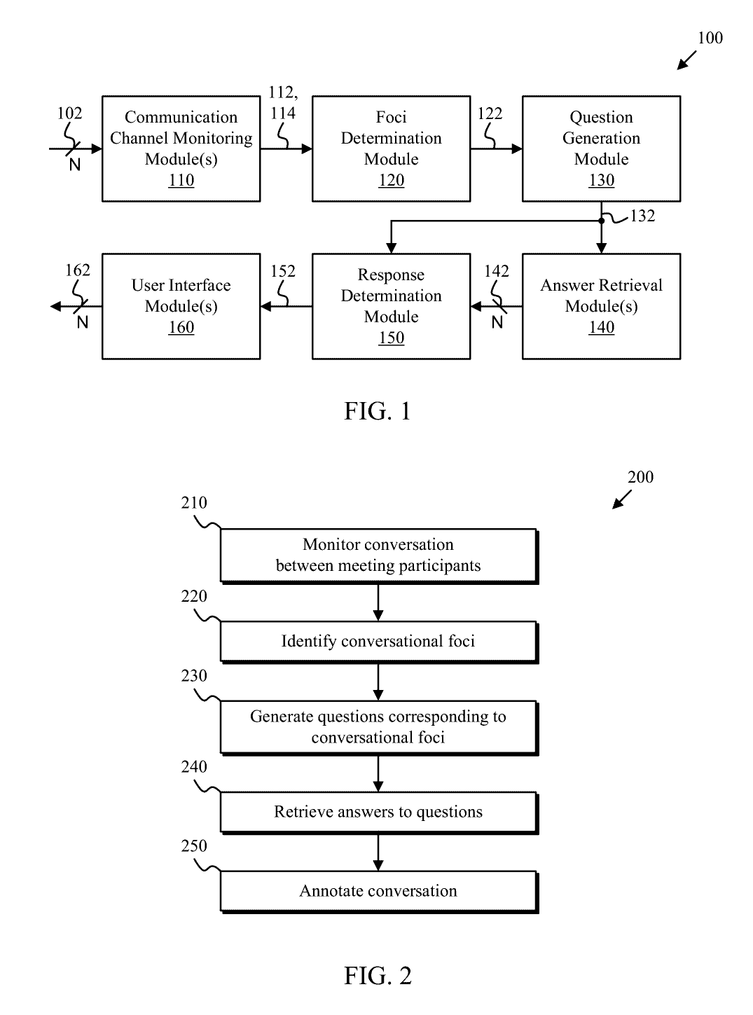

Various embodiments will now be described in reference to the Figures. For example, FIG. 1 is a functional block diagram depicting one example of a conversation enhancement system 100 in accordance with at least one embodiment of the present invention. As depicted, the conversation enhancement system 100 includes one or more monitoring modules 110, a foci determination module 120, a question generation module 130, one or more answer retrieval modules 140, a response determination module 150, and one or more user interface modules 160. The conversation enhancement system 100 improves the effectiveness of conversations.

The monitoring modules 110 monitor one or more communication channels 102 and extract content 112 communicated in a conversation between participants (not shown). The communication channels 102 may support a variety of communications between participants in the conversation including verbal communication, visual communication, and text-based communication. In some embodiments, the content 112 is text-based content and non-textual forms of communication are converted to text to provide the content 112. For example, speech recognition may be used to convert verbal communication to text.

Each user may participant in the conversation via one or more electronic devices (not shown) such as cell phones or computers that are connected to the communication channels 102. In one embodiment, each monitoring module 110 monitors a single communication channel 102 and provides the content 112 to the foci determination module 120. In some embodiments, the monitoring modules 110 may also provide prosody information 114 to the foci determination module 120.

The foci determination module 120 receives the content 112 and prosody information 114 and determines at least one conversational focus 122 therefrom. In some embodiments, the conversational focus 122 is determined by extracting keywords from the content 112 and conducting a term frequency, inverse-document frequency analysis. Grammatical analysis (e.g., that determines phrases and parts of speech) may also be used to identify the conversational focus 122. The conversational focus 122 may be updated over the course of the conversation. In some embodiments, the content 112 (or information extracted therefrom) is retained over time and the foci determination model 120 weights the content 112 according to how recently the content was extracted from the communication channels 102. By weighting the content 112 according to “recency” the conversational focus 122 may account for conversational context while remaining sensitive to changes in focus.

The prosody information 114 may also be factored into the process for determining the conversational focus 122. For example, a rise or significant change in the pitch of the speaker may indicate, or correspond with, a conversational focus. Consequently, keywords or parts of speech used to determine the conversational focus may be weighted according to the prosody information 114.

The question generation module 130 receives the conversational foci 122 and generates at least one question 132 therefrom. In some embodiments, generating at least one question comprises comparing the current conversational focus 122 with information that is likely available from other sources such as transcripts from previous meetings, product literature, financial databases, employee directories, web pages, and the like. For example, metadata or catalog information for each information source may describe the type of information that is available from that source.

Based on the difference between the information that is likely available from other sources (that is relevant to the current conversational focus) and the information that is likely to be already known by the participant, a likely knowledge gap (not shown) of the participant may be determined. The likely knowledge gap of the participant and the conversational focus may be used to determine which questions and corresponding answers may be most pertinent to each participant for the current conversational focus 122.

In some embodiments, multiple trainable question generation models (not shown) are maintained by the question generation module 130 that are tuned to specific meeting topics, specific users, situation specific triggers, and the like. For instance user specific models might be built on the expertise of users and also account for their interests. For example, someone in a managerial role is likely to be less interested in implementation details and more likely to be interested in questions and answers concerning project deadlines and timelines. For such a user the system could generate more questions in the form “who is the expert on situational awareness”, “what are the deliverables discussed last week”. User specific models can be initially seeded with user's information derived from some sources or explicitly fed in and then adapt based on feedback. The situation model on the other hand may trigger questions for events like somebody joining late or a new person participating in a recurring meeting. Therefore the situation specific models enable adapting to the form of a meeting and the set of participants. With an ensemble of trainable question generation models such as the described models, which adapt over time, the system 100 can generate focused questions for each user.

The answer retrieval modules 140 receive the questions 132 and provide one or more answers 142 corresponding to the questions. The questions 132 or answers 142 may incorporate at least one previous question. In some embodiments, the answer retrieval modules 140 send the questions to one or more question and answer systems (not shown). The answers may include a confidence score. In certain embodiments, multiple question and answer systems provide answers 142 and associated confidence scores. In some embodiments, the question answering systems are open domain systems that are not limited to a particular knowledge domain. However, the knowledge base and other data sources used by the Q/A systems may be augmented with domain specific knowledge bases as well as content extracted from, or provided to, previous meetings. Consequently, the Q/A systems may have an updated context for the current meeting based on previous meetings including meetings or portions of meetings for which the participants were not present but have been granted access.

The response determination module 150 receives the questions 132, answers 142, and any associated information such as confidence levels and determines a response 152 therefrom for one or more participants. The response 152 may be personalized to each participant. Examples of responses include presenting a question and answer to the user and/or presenting a link to more detailed information.

Each user interface module 160 receives a response 152 for a participant and provides, where appropriate, annotations 162 to a conversation. An example of annotations includes text and/or hypertext annotations on a transcript of a conversation. The transcript may be generated in real-time or subsequent to the conversation. The annotations presented to each participant may be identical, similar, or dissimilar. The annotations may present information (i.e., content) in a variety of information bearing forms (e.g., text, graphics, videos, audio segments, charts, graphs, and the like). The annotations may also include hyperlinks to such information.

In some embodiments, the user interface module 160 collects explicit and/or implicit feedback from the users. The feedback can be used to change the conversational foci and provide feedback on question and answer quality to the various elements of the system 100. Examples of explicit feedback include a user “liking” or “disliking” an answer via a user interface element [OTHERS?]. Examples of implicit feedback include collecting information on user interactions with content such as lingering time or link clicking.

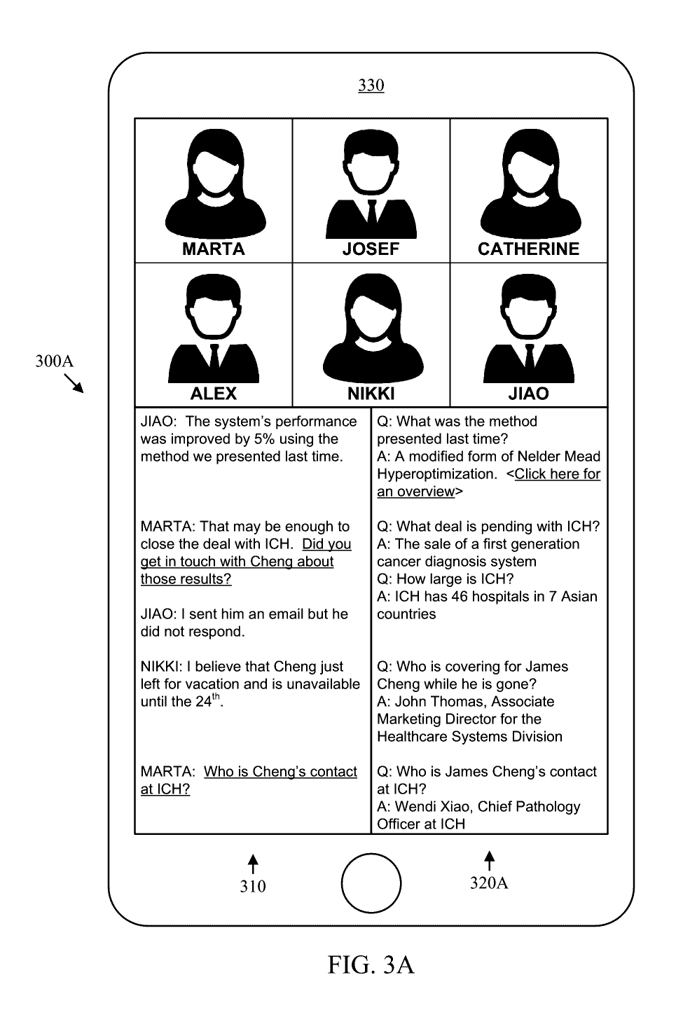

FIG. 2 is a flowchart depicting one example of a conversation enhancement method 200 in accordance with at least one embodiment of the present invention. As depicted, the conversation enhancement method 200 includes monitoring (210) a conversation, identifying (220) foci of the conversation, generating (230) questions, retrieving (240) answers, and annotating (250) the conversation. The conversation enhancement method 200 may be conducted by the conversation enhancement system 100 or the like.

Monitoring (210) a conversation may include monitoring communications between participants in a conversation. The communications may be conducted over a variety of communication channels such as audio communication channels, video communication channels, and text-based communication channels. Identifying (220) foci of the conversation may include converting the communications to text and determining keywords and/or parts of speech within the text. In some embodiments, questions within the conversation are identified, marked and/or punctuated in the transcript as questions, and used as candidates for the conversational focus. Generating (230) questions may include deriving questions from the keywords or parts of speech.

Retrieving (240) answers may include sending the questions to an automated Q/A system and receiving answers from the Q/A system. In some embodiments, the retrieved answers are used to update the Q/A system based on explicit or implicit user feedback to the questions and answers. The Q/A system may be a deep Q/A system.

Annotating (250) the conversation may include presenting information corresponding to the question and/or answer to one or more meeting participants. The information may be personalized to the knowledge, skills, interests, and roles of each participant. The information may confirm, refute, or augment information within the meeting conversation. In some embodiments, the information is presented as annotations for the conversation. The annotations may be in-line with, outside of, or independent of, a transcription of the conversation (if any).

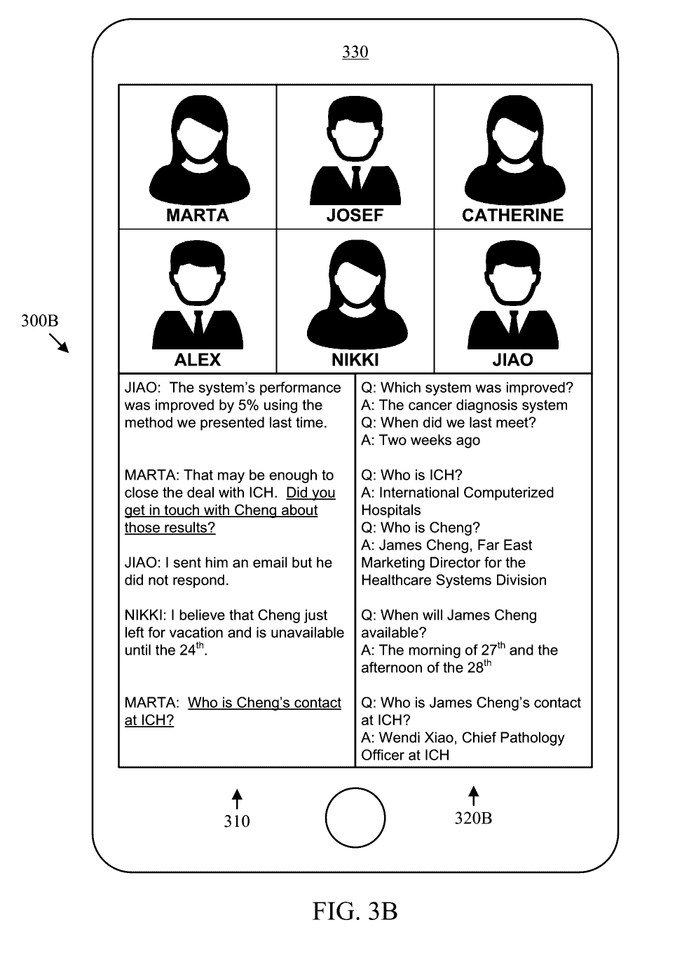

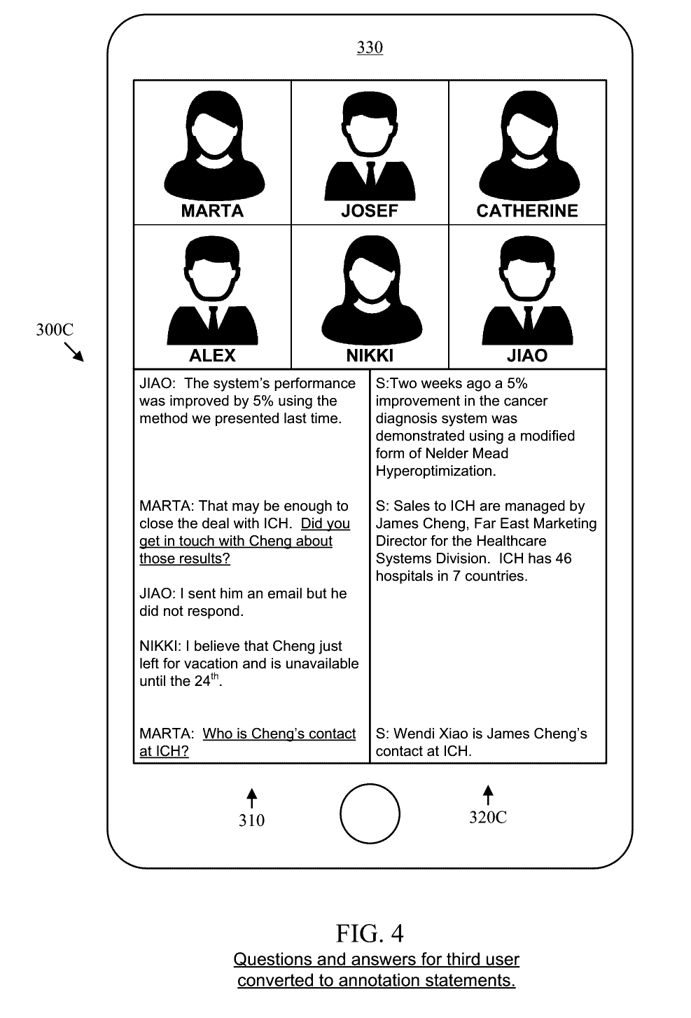

FIGS. 3A, 3B, and 4 are illustrations depicting several examples of an annotated conversation 300 (i.e., 300A, 300B, and 300C) in accordance with at least one embodiment of the present invention. As depicted, each annotated conversation 300 includes a displayed transcript 310 and displayed annotations 320. In the depicted examples, the displayed transcript 310 is essentially identical although differently spaced to align with the displayed annotations 320. However, in the depicted examples the displayed annotations 320 (i.e., 320A, 320B and 320C) are different for each participant.

Each meeting participant may have access to one or more display devices 330 that present the displayed transcript 310 and the displayed annotations 320 to that particular participant. For purposes of comparison, the annotated conversations 300 are displayed on essentially identical mobile devices 330 but the invention is not so limited. In the depicted examples, questions within the displayed transcript 310 are identified, punctuated as questions, and underlined for emphasis. Prosody information may be used, along with grammatical analysis, to identify the questions.

In the annotated conversation 300A shown in FIG. 3A, the meeting participant that is using the display device 330 is assumed to be a technical salesperson (NIKKI) that is interested in the technology behind the discussed system, the size of the sales opportunity, and the organizational contacts that are important to making such sales. The generated questions and answers reflect those interests.

In the annotated conversation 300B shown in FIG. 3B, the meeting participant that is using the display device 330 is assumed to be a marketing manager (JOSEF) that arrived late to the meeting and has a need to understand the context of the conversation. The generated questions and answers reflect that need.

In the annotated conversation 300C shown in FIG. 4, the meeting participant that is using the display device 330 is assumed to be a product manager (CATHERINE) that is interested in the performance of the system and of the size of the market opportunity in general. The generated statements reflect those interests. While the displayed annotations 320A and 320B are shown to the participants in a question and answer format, the displayed annotations 320C are shown in a statement format where each statement corresponds to a question and an answer.

The embodiments disclosed herein annotate a conversation that occurs between meeting participants so that each meeting participant can understand and effectively participate in the conversation. One of skill in the art will appreciate that the displayed annotations may be personalized to the needs, interests, skills, roles, knowledge (including previous participation) of each meeting participant.

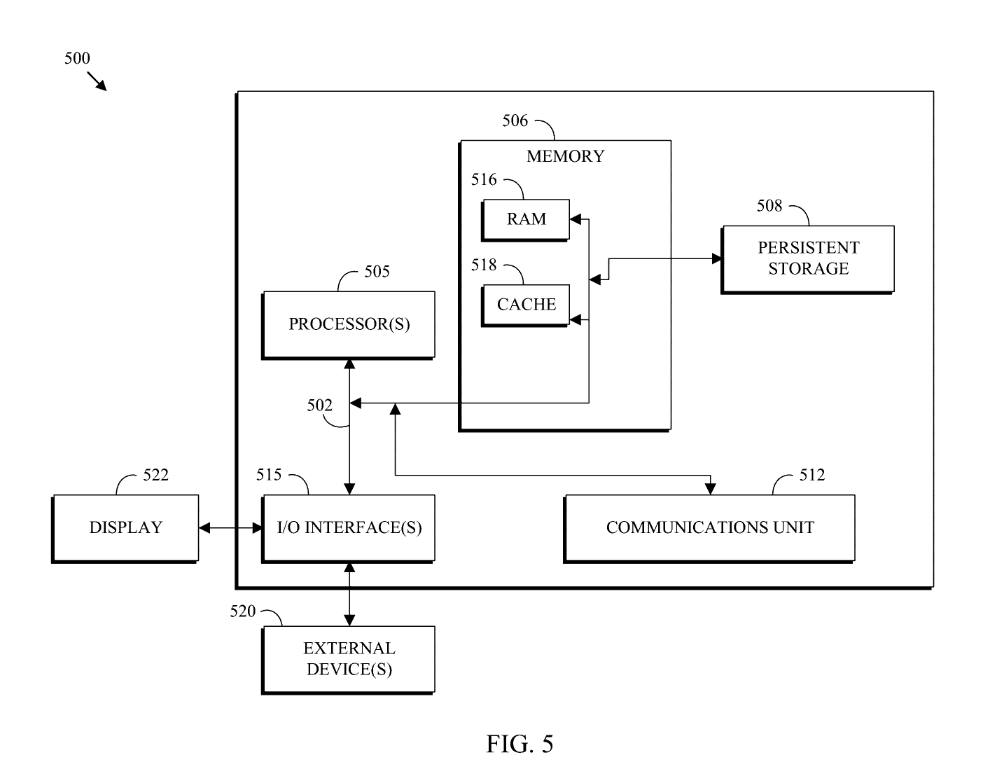

FIG. 5 is a block diagram depicting components of one example of a computer 500 suitable for executing the methods disclosed herein. It should be appreciated that FIG. 5 provides only an illustration of one embodiment and does not imply any limitations with regard to the environments in which different embodiments may be implemented. Many modifications to the depicted environment may be made.

As depicted, the computer 500 includes communications fabric 502, which provides communications between computer processor(s) 505, memory 506, persistent storage 508, communications unit 512, and input/output (I/O) interface(s) 515. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In the depicted embodiment, memory 506 includes random access memory (RAM) 516 and cache memory 518. In general, memory 506 can include any suitable volatile or non-volatile computer readable storage media.

One or more programs may be stored in persistent storage 508 for execution by one or more of the respective computer processors 505 via one or more memories of memory 506. The persistent storage 508 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 512, in these examples, provides for communications with other data processing systems or devices. In these examples, communications unit 512 includes one or more network interface cards. Communications unit 512 may provide communications through the use of either or both physical and wireless communications links.

I/O interface(s) 515 allows for input and output of data with other devices that may be connected to computer 500. For example, I/O interface 515 may provide a connection to external devices 520 such as a keyboard, keypad, a touch screen, and/or some other suitable input device. External devices 520 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 508 via I/O interface(s) 515. I/O interface(s) 515 also connect to a display 522. Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The embodiments disclosed herein include a system, a method, and/or a computer program product. The computer program product may include a computer readable storage medium (or media) having computer readable program instructions thereon for causing a processor to carry out the methods disclosed herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, executed by one or more processors, the method comprising:
monitoring a conversation between a plurality of meeting participants;
identifying a conversational focus within the conversation;
generating at least one question corresponding to the conversational focus; and
retrieving at least one answer corresponding to the at least one question.

2. The method of claim 1, further comprising presenting information to a meeting participant corresponding to the at least one question or the at least one answer.

3. The method of claim 1, wherein an answer is retrieved from an automated Q/A system.

4. The method of claim 3, further comprising using the answer to update the automated Q/A system.

5. The method of claim 1, wherein the conversation comprises one or more of verbal communication, visual communication, and text-based communication.

6. The method of claim 1, wherein the at least one question or the at least one answer incorporates at least one previous question.

7. The method of claim 1, wherein the at least one question or the at least one answer is personalized to a knowledge level of a meeting participant.

8. The method of claim 1, wherein prosody information is used to determine the conversational focus.

9. The method of claim 1, wherein the conversational focus corresponds to a question within the conversation.

10. The method of claim 1, wherein prosody information is used to identify questions within the conversation.

11. The method of claim 1, informing a meeting participant of one or more questions within the conversation.

12. A computer program product comprising:
one or more computer readable storage media and program instructions stored on the one or more computer readable storage media, the program instructions comprise instructions for:
monitoring a conversation between a plurality of meeting participants;
identifying a conversational focus within the conversation;
generating at least one question corresponding to the conversational focus; and
retrieving at least one answer corresponding to the at least one question.

13. The computer program product of claim 12, wherein the program instructions comprise instructions for presenting information to a meeting participant corresponding to the at least one question or the at least one answer.

14. The computer program product of claim 12, wherein an answer is retrieved from an automated Q/A system.

15. The computer program product of claim 14, wherein the program instructions comprising instructions for using the answer to update the automated Q/A system.

16. The computer program product of claim 12, wherein the conversation comprises one or more of verbal communication, visual communication, and text-based communication.

17. The computer program product of claim 12, wherein the at least one question or the at least one answer incorporates at least one previous question.

18. The computer program product of claim 12, wherein the at least one question or the at least one answer is personalized to a knowledge level of a meeting participant.

19. A computer system comprising:
a question answering system;
one or more computer processors;
one or more computer readable storage media;
program instructions stored on the computer readable storage media for execution by at least one of the computer processors, the program instructions comprising instructions for:
monitoring a conversation between a plurality of meeting participants;
identifying a conversational focus within the conversation;
generating at least one question corresponding to the conversational focus; and
retrieving at least one answer corresponding to the at least one question from the question answering system.

20. The computer system of claim 19, wherein the program instructions comprising instructions for presenting information to a meeting participant corresponding to the at least one question or the at least one answer.
